(19) United States
(12) Patent Application Publication
(10) Pub. No.: US 2026/0185777 A1
(43) Pub. Date: Jul. 2, 2026

(54) GRAPHITIZATION FURNACE AND METHOD FOR PREPARING ARTIFICIAL GRAPHITE

(71) Applicant: SK ON CO., LTD., Seoul (KR)

(72) Inventors: Kyung Hoon KIM, Daejeon (KR); Jong Hyuk LEE, Daejeon (KR); So Hyun PARK, Daejeon (KR); Chan Young JEON, Daejeon (KR)

(21) Appl. No.: 19/351,450

(22) Filed: Oct. 7, 2025

(30) Foreign Application Priority Data
Oct. 8, 2024 (KR) 10-2024-0136658

(51) Int. Cl. F27B 14/06; C01B 32/205

(52) U.S. Cl. CPC F27B 14/06; C01B 32/205

(57) ABSTRACT

A box-type graphitization furnace according to embodiments of the present disclosure includes a heating chamber, a first power electrode and a second power electrode disposed at opposite ends of the heating chamber, and a heating plate that is in contact with a bottom surface of the heating chamber and connected to the first power electrode and the second power electrode so as to extend across the interior of the heating chamber. Accordingly, the box-type graphitization furnace may reduce the temperature gradient between the central and peripheral portions, thereby obtaining artificial graphite having a uniform degree of graphitization. In addition, lithium secondary batteries manufactured using the artificial graphite may have a uniform capacity.

### CROSS-REFERENCE TO RELATED APPLICATIONS

This application claims priority under 35 U.S.C. § 119 to Korean Patent Application No. 10-2024-0136658, filed on Oct. 8, 2024 in the Korean Intellectual Property Office (KIPO), the entire disclosures of which are incorporated by reference herein.

### BACKGROUND OF THE INVENTION

### 1. Field of the Invention

The present disclosure relates to a graphitization furnace and a method for preparing artificial graphite. More specifically, the present disclosure relates to a box-type graphitization furnace and a method for preparing artificial graphite using the box-type graphitization furnace.

### 2. Description of the Related Art

Artificial graphite is widely used in fields such as anode materials for secondary batteries, iron and steelmaking electrodes, electrical discharge machining electrodes, nuclear fusion reactors, semiconductors, and solar cells. Although artificial graphite has a lower degree of graphitization and a higher price due to manufacturing process costs compared to natural graphite, it has the advantage of relatively superior lifetime properties, making it a popular anode material for secondary batteries.

Generally, artificial graphite is prepared by stacking crucibles filled with raw materials for artificial graphite in a graphitization furnace, filling the furnace with resistive materials and insulating materials so that the crucibles are embedded, and then indirectly heating the crucibles using resistive heat generated by current, thereby graphitizing the raw materials within the crucibles.

For example, artificial graphite may be prepared using an Acheson graphitization furnace. However, the Acheson graphitization furnace is energy inefficient, has long operating times, and requires a large number of cylindrical crucibles and resistive materials, making it expensive and difficult to operate.

A box-type graphitization furnace, which compensates for the shortcomings of the Acheson graphitization furnace, directly applies current to large crucibles, resulting in higher energy efficiency, shorter operating times, and easier processing. However, due to the use of large crucibles, the temperature gradient between the central and peripheral portions (the crucible wall) increases, making it difficult to obtain artificial graphite having a uniform degree of graphitization.

### SUMMARY OF THE INVENTION

An object of the present disclosure is to provide a graphitization furnace having a reduced temperature gradient between the central and peripheral portions.

Another object of the present disclosure is to provide a method for preparing artificial graphite having a uniform degree of graphitization using the graphitization furnace.

A box-type graphitization furnace according to some embodiments of the present disclosure includes: a heating chamber; a first power electrode and a second power electrode disposed at opposite ends of the heating chamber; and a heating plate that is in contact with a bottom surface of the heating chamber and connected to the first power electrode and the second power electrode so as to extend across the interior of the heating chamber.

In some embodiments, the heating plate may be connected perpendicularly to the first power electrode and the second power electrode.

In some embodiments, the heating plate may be connected to a central portion of the first power electrode and a central portion of the second power electrode.

In some embodiments, the heating plate may be made of graphite.

In some embodiments, the heating plate may be inserted into a groove formed in the bottom surface of the heating chamber.

In some embodiments, the heating plate may be in contact with the first power electrode from a lower portion to an upper portion and with the second power electrode from the lower portion to the upper portion.

In some embodiments, a region inside the heating chamber may be divided into two regions by the heating plate.

In some embodiments, the heating plate may be in contact with a cover at the upper portion of the heating chamber.

A method for preparing artificial graphite according to some embodiments of the present disclosure includes: charging the above-described box-type graphitization furnace with raw materials; and heat-treating the raw materials to perform graphitization.

In some embodiments, the heat treatment may be performed by resistive heat generated by current.

The box-type graphitization furnace according to some embodiments may reduce the temperature gradient between the central and peripheral portions, thereby obtaining artificial graphite having a uniform degree of graphitization.

The method for preparing artificial graphite according to some embodiments may obtain artificial graphite with reduced variation in the degree of graphitization. Therefore, lithium secondary batteries manufactured using the artificial graphite may have a uniform capacity.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a perspective view of a box-type graphitization furnace according to some embodiments;

FIG. 2 is a plan view of the box-type graphitization furnace according to some embodiments;

FIG. 3 is a cross-sectional view of the box-type graphitization furnace according to some embodiments;

FIG. 4 is a plan view of a box-type graphitization furnace according to some embodiments;

FIG. 5 is a plan view of a box-type graphitization furnace according to Comparative Example 1;

FIG. 6 is a plan view of a box-type graphitization furnace according to Comparative Example 2;and

FIGS. 7 and 8 are a perspective view and a plan view, respectively, of a box-type graphitization furnace according to Comparative Example 3.

### DETAILED DESCRIPTION OF THE INVENTION

A box-type graphitization furnace according to some embodiments includes a heating chamber; a first power electrode and a second power electrode disposed at opposite ends of the heating chamber; and a heating plate that is in contact with a bottom surface of the heating chamber and connected to the first power electrode and the second power electrode so as to extend across the interior of the heating chamber.

Therefore, the box-type graphitization furnace may reduce the temperature gradient between the central and peripheral portions, thereby obtaining artificial graphite having a uniform degree of graphitization. In addition, lithium secondary batteries manufactured using the artificial graphite may have a uniform capacity.

Hereinafter, the embodiments of the present disclosure will be described in more detail with reference to the accompanying drawings. However, the drawings attached to the present disclosure are merely illustrative of some embodiments of the present disclosure to aid in understanding the technical spirit of the disclosure together with the foregoing description. Therefore, the present disclosure should not be construed as being limited to the matters illustrated in the drawings.

As used herein, the terms “upper surface,” “lower surface,” “upper portion,” “lower portion,” “bottom surface,” “bottom portion,” and the like are used in a relative sense to distinguish the positions of components, and do not specify absolute positions.

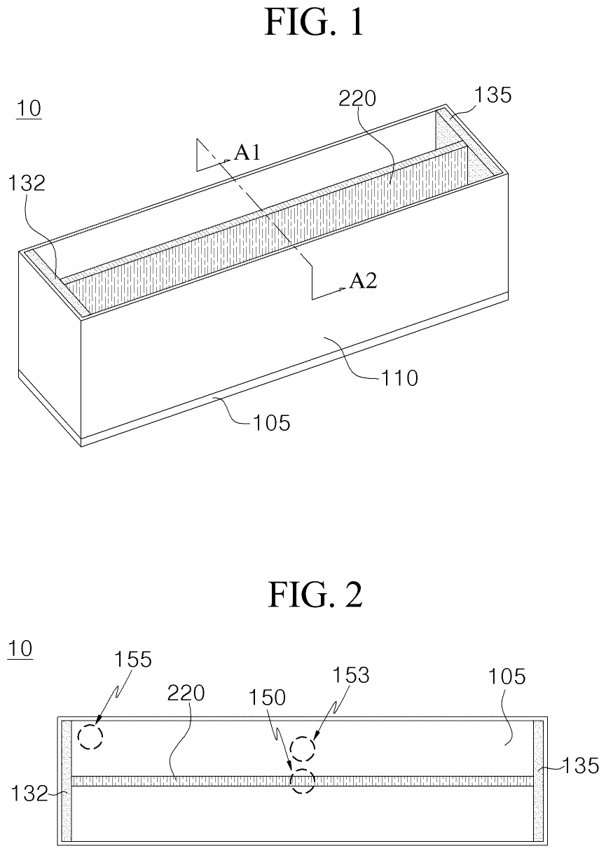

FIG. 1 is a perspective view of a box-type graphitization furnace according to some embodiments.

Referring to FIG. 1, a box-type graphitization furnace 10 may include a heating chamber 110 and a first power electrode 132 and a second power electrode 135 disposed at opposite ends of the heating chamber 110. The heating chamber 110 may serve as a space into which raw materials for artificial graphite are introduced and in which the raw materials are heat-treated to perform graphitization. The first power electrode 132 and the second power electrode 135 may generate heat through resistive heating when current flows through them.

In some embodiments, the box-type graphitization furnace 10 may include a cover (not shown in the drawings) on the upper portion. The cover may seal the heating chamber 110, thereby facilitating heat treatment for graphitization.

When the first power electrode 132 and the second power electrode 135 generate heat at opposite ends of the heating chamber 110, the temperature within the heating chamber 110 may rise to a temperature sufficient to facilitate graphitization. For example, the temperature may range from 2500° C. to 3500° C., 2700° C. to 3300° C., 2800° C. to 3200° C., or 2900° C. to 3100° C., and artificial graphite having a high degree of graphitization may be obtained within the above range.

The spaces around the opposite ends of the heating chamber 110, where the first power electrode 132 and the second power electrode 135 are disposed, i.e., the peripheral portions of the heating chamber 110, may maintain the temperature within the above range. However, the central portion between the first power electrode 132 and the second power electrode 135 (for example, a region perpendicular to the plane formed by the heating plate 220 passing through the middle region between the first power electrode 132 and the second power electrode 135 of the heating plate 220, for example, the region near the A1-A2 line) may have a lower temperature than the peripheral portions due to insufficient heat transfer. Accordingly, the artificial graphite prepared from the raw materials in the central portion may have a low degree of graphitization.

Therefore, if the temperature gradient between the central and peripheral portions of the heating chamber 110 is high, the degree of graphitization of the artificial graphite prepared from the raw materials in the central portion and the artificial graphite prepared from the raw material in the peripheral portion may not be uniform. In addition, a lithium secondary battery manufactured using artificial graphite with large variation in the degree of graphitization may not have a uniform capacity.

FIG. 2 is a plan view of the box-type graphitization furnace according to some embodiments. For example, FIG. 2 is a plan view illustrating the structure of a bottom surface 105 of the heating chamber 110.

Referring to FIGS. 1 and 2, the box-type graphitization furnace 10 may include a heating plate 220 that is in contact with the bottom surface 105 of the heating chamber 110 and connected to the first power electrode 132 and the second power electrode 135 so as to extend across the interior of the heating chamber 110. When the first power electrode 132 and the second power electrode 135 generate heat, the heating plate 220 may also generate heat at substantially the same temperature. Therefore, the space around the heating plate 220 may also be maintained at a temperature sufficient for graphitization, and the temperature range is as described above.

In some embodiments, the heating chamber 110 may be divided into two regions. For example, the heating plate 220 may be in contact with the bottom surface 105, thereby dividing the heating chamber 110 into two regions. Accordingly, the temperature in each region may effectively rise, thereby reducing the temperature gradient and obtaining artificial graphite having a uniform degree of graphitization.

As shown in FIG. 1, in some embodiments, the heating plate 220 may be in contact with the first power electrode 132 from the lower portion to the upper portion, and with the second power electrode 135 from the lower portion to the upper portion. Accordingly, the heating chamber 110 may be completely divided into two regions, and the heat generated by the first power electrode 132, the second power electrode 135, and the heating plate 220 may be effectively transferred to the raw materials for artificial graphite.

In some embodiments, the heating plate 220 may be in contact with the cover (not shown) at the upper portion of the heating chamber 110. Accordingly, the heating chamber 110 may be divided into two regions, thereby enabling effective graphitization.

In some embodiments, the heating plate 220 may be connected perpendicularly to the first power electrode 132 and the second power electrode 135. Accordingly, heat generated by the heating plate 220 may be effectively transferred throughout the entire heating chamber 110.

If the heat generated by the heating plate 220 is also transferred to the central portion, the temperature gradient in the heating chamber 110 may be reduced compared to when only the first power electrode 132 and the second power electrode 135, which are disposed at opposite ends of the heating chamber 110, generate heat. Therefore, artificial graphite having a uniform degree of graphitization may be obtained, and the capacity of a lithium secondary battery manufactured using the artificial graphite may be more uniform.

In some embodiments, the heating plate 220 may be connected to a central portion of the first power electrode 132 and a central portion of the second power electrode 135. Accordingly, as shown in FIG. 2, the bottom surface 105 of the heating chamber 110 may be divided into two regions having the same area. As a result, heat generated by the heating plate 220 may be effectively transferred to the divided regions of the heating chamber 110, and the variation in the degree of graphitization of the prepared artificial graphite may be reduced.

In some embodiments, the heating plate 220 may be made of graphite. Accordingly, when power is applied to the heating plate 220, it may generate heat at a high temperature, and the raw materials for artificial graphite around the heating plate 220 may be graphitized.

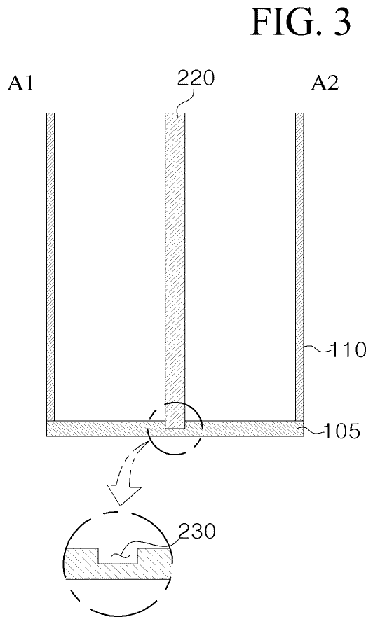

FIG. 3 is a cross-sectional view of the box-type graphitization furnace according to some embodiments. Specifically, FIG. 3 is a cross-sectional view taken along line A1-A2 of FIG. 1 in the thickness direction.

Referring to FIG. 3, the bottom surface 105 of the heating chamber 110 may include a groove 230. In an embodiment, the heating plate 220 may be inserted into the groove 230 formed in the bottom surface 105 within the heating chamber 110. Accordingly, the heating plate 220 may be firmly installed and effectively bisect the bottom surface 105 of the heating chamber 110.

In some embodiments, the heating plate 220 may have a rectangular shape. Accordingly, the heating plate 220 may be easily inserted into the groove 230 formed in the bottom surface 105 of the heating chamber 110, and the heating chamber 110 may be easily divided into two regions. Accordingly, the temperature gradient throughout the entire space of the heating chamber 110 may be reduced, thereby obtaining artificial graphite having a uniform degree of graphitization.

In some embodiments, all external surfaces of the heating chamber 110 may have a rectangular shape. For example, the side surfaces, the upper surface, and the bottom surface of the heating chamber 110 may have a rectangular shape.

Hereinafter, a method for preparing artificial graphite using the above-described box-type graphitization furnace will be described.

In some embodiments, artificial graphite may be prepared by filling the above-described box-type graphitization furnace with raw materials and heat-treating the raw materials to perform graphitization.

For example, the raw material may be an inorganic material containing carbon, which may be converted into artificial graphite through heat treatment. In an embodiment, the raw material may be coke, preferably in the form of powdered coke.

The raw material filled in the box-type graphitization furnace may be heat-treated at a high temperature of 2500° C. or higher to be graphitized. For example, the heat treatment temperature may range from 2500° C. to 3500° C., 2700° C. to 3300° C., 2800° C. to 3200° C., or 2900° C. to 3100° C. For example, the heat treatment time may be 10 hours to 3 days or 1 day to 7 days. For example, the pressure during the heat treatment may be 700 torr to 760 torr.

In some embodiments, the heat treatment may be performed by resistive heat generated by current. For example, when current flows through the first power electrode 132 and the second power electrode 135, resistive heat may be generated, and the temperature of the space (peripheral portion) around the opposite ends of the heating chamber 110 may increase.

In addition, since the heating plate 220 connected to the first power electrode 132 and the second power electrode 135 may also generate heat at substantially the same temperature, the temperature of the space around the heating plate 220 may also increase. As described above, since the heating plate 220 may extend across the central portion (line A1-A2 of FIG. 1), the temperature of the central portion may also increase sufficiently to facilitate graphitization.

Therefore, the artificial graphite prepared according to some embodiments may have a uniform degree of graphitization and may be used to manufacture lithium secondary batteries with uniform capacity.

Hereinafter, experimental examples including specific examples and comparative examples are presented to aid in the understanding of the present disclosure. However, these examples are provided merely for illustrative purposes of the present disclosure and are not intended to limit the scope of the appended claims. It will be apparent to those skilled in the art that various changes and modifications can be made within the scope and spirit of the present disclosure, and such changes and modifications are to be regarded as falling within the scope of the appended claims.

### Example 1

### (1) Preparation of Box-Type Graphitization Furnace

A box-type graphitization furnace was prepared, as shown in FIGS. 1 and 2.

The box-type graphitization furnace 10 included the heating chamber 110, the first power electrode 132 and the second power electrode 135 disposed at opposite ends of the heating chamber 110, and the heating plate 220 that was in contact with the bottom surface 105 of the heating chamber 110 and connected to the first power electrode 132 and the second power electrode 135 so as to extend across the interior of the heating chamber 110.

In addition, the heating plate 220 was connected to the central portion of the first power electrode 132 and the central portion of the second power electrode 135, and was in contact with the cover at the upper portion of the heating chamber 110.

### (2) Preparation of Artificial Graphite

Artificial graphite was prepared by filling the prepared box-type graphitization furnace 10 with powdered coke, heating the furnace to 3000° C., and maintaining the temperature for 2 days to perform graphitization.

Referring to FIG. 2, the bottom surface 105 of the heating chamber 110 included a peripheral portion A 155, a central portion A 150, and a central portion B 153. Artificial graphite was collected from each of the peripheral portion A 155, the central portion A 150, and the central portion B 153.

### (3) Manufacture of Lithium Half Cell

The artificial graphite collected from the peripheral portion A 155, the central portion A 150, and the central portion B 153 described above was separately used to manufacture a lithium secondary battery.

The prepared artificial graphite, styrene-butadiene rubber (SBR), and carboxymethyl cellulose (CMC) were dispersed in water in a weight ratio of 97:1.5:1.5 to prepare an anode slurry. The anode slurry was coated onto a copper foil to fabricate an anode. Subsequently, a lithium secondary battery was manufactured using the anode and lithium metal as a counter electrode (cathode).

A separation membrane (polyethylene, thickness: 20 μm) was interposed between the fabricated anode and the lithium metal (thickness: 2 mm), thereby forming a lithium coin half-cell.

The lithium metal/separation membrane/anode assembly was placed in a coin cell plate, and after injecting an electrolyte, a cap was then mounted and clamped. A 1M LiPF₆ solution prepared using a mixed solvent of EC/FEC/EMC/DEC (20/10/20/50; volume ratio) was used as the electrolyte. After clamping, the plate was impregnated for 12 hours or more, and then three charge-discharge cycles were performed at 0.1C (charging conditions: CC-CV 0.1C 0.01 V 0.01C cut-off, discharging conditions: CC 0.1C 1.5 V cut-off).

### Example 2

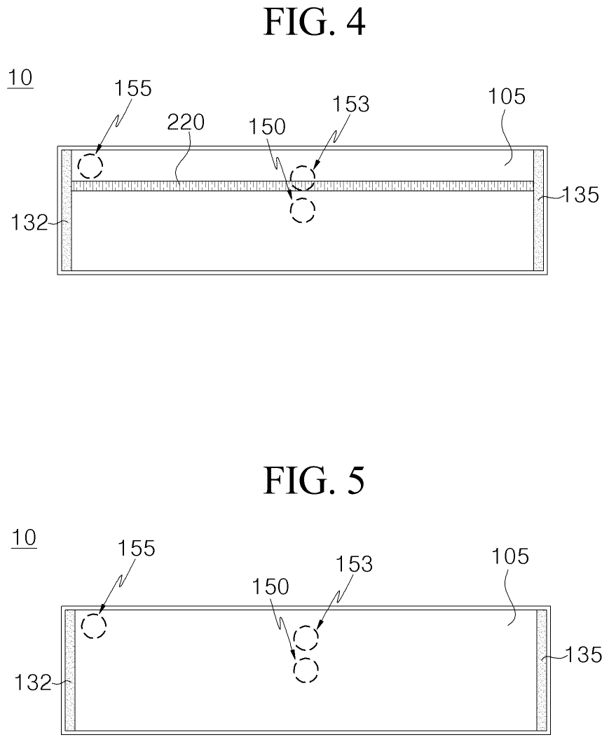

A box-type graphitization furnace having the same structure as Example 1 was prepared, except that the heating plate 220 was not connected to the central portion of the first power electrode 132 and the central portion of the second power electrode 135. FIG. 4 shows a plan view of the box-type graphitization furnace. Thereafter, artificial graphite and a lithium half cell (Li-half cell) were manufactured in the same manner as in Example 1.

### Comparative Example 1

A box-type graphitization furnace having the same structure as Example 1 was prepared, except that the heating plate 220 was omitted. FIG. 5 shows a plan view of the box-type graphitization furnace. Artificial graphite and a lithium half cell (Li-half cell) were manufactured in the same manner as in Example 1.

### Comparative Example 2

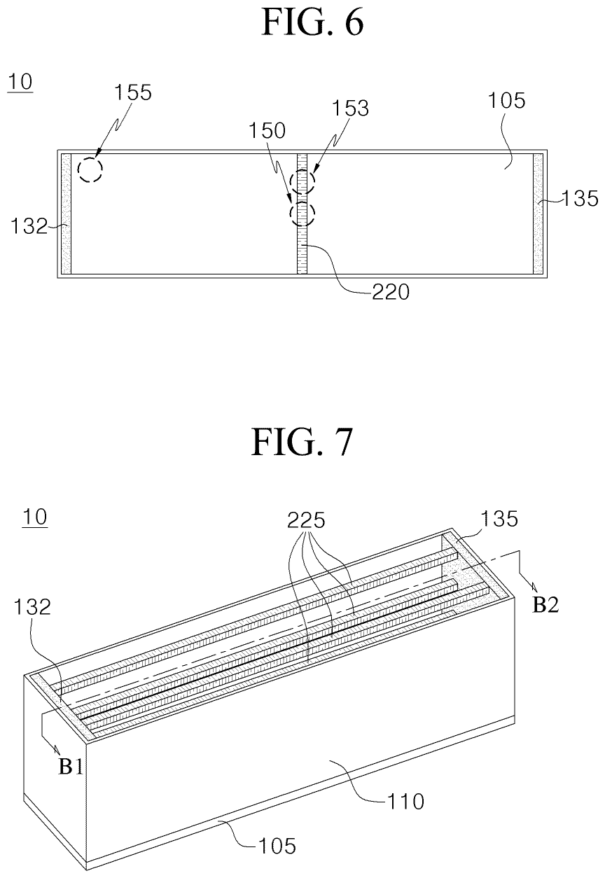

A box-type graphitization furnace having the same structure as Example 1 was prepared, except that the heating plate 220 was disposed so as to cross the interior of the heating chamber 110 without being connected to the first power electrode 132 and the second power electrode 135. FIG. 6 shows a plan view of the box-type graphitization furnace. Artificial graphite and a lithium half cell (Li-half cell) were manufactured in the same manner as in Example 1.

### Comparative Example 3

A box-type graphitization furnace having the same structure as Example 1 was prepared, except that it included a plurality of heating rods 225 connected to the first power electrode 132 and the second power electrode 135, instead of the heating plate 220, and was not in contact with the bottom surface 105 of the heating chamber 110, and the bottom surface 105 did not have the groove 230.

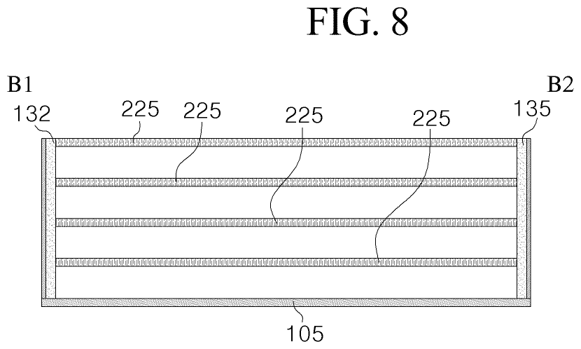

FIGS. 7 and 8 show a perspective view and a plan view (cut lengthwise) of the box-type graphitization furnace, respectively. Artificial graphite and a lithium half cell (Li-half cell) were then manufactured in the same manner as in Example 1.

### Experimental Example

### (1) Evaluation of Graphitization Degree

The graphitization degree of the artificial graphite prepared according to the above-described examples and comparative examples was evaluated for the peripheral portion A 155, the central portion A 150, and the central portion B 153. Specifically, the degree of graphitization was evaluated using Equation 1 below, based on the d002 value obtained through X-ray diffraction (XRD) analysis.

$$[ Equation 1 ]$$

$$Graphitization degree ( \% ) = ( 3.440 - d 002 ) / ( 3.440 - 3.354 ) \times 100$$

The results of the graphitization degree evaluation are shown in Table 1, and the numerical values in Table 1 are expressed in percent (%).

### (2) Measurement of Discharge Capacity

Lithium secondary batteries manufactured according to the above-described examples and comparative examples were discharged (CC-CV 0.1C 0.05 V 0.01C cut-off) in a 25° C. chamber, and then further discharged to 1.5 V to measure the battery capacity (discharge capacity).

The results of the discharge capacity evaluation are shown in Table 2, and the numerical values in Table 2 are expressed in mAh/g.

TABLE 1

| | Central | Central | Peripheral |
|---|---|---|---|
| Graphitization | portion | portion | portion |
| degree (%) | A 150 | B 153 | A 155 |
| Example 1 | 85.3 | 84.9 | 85.1 |
| Example 2 | 82.8 | 83.1 | 83.3 |
| Comparative | 80.4 | 81.2 | 82.1 |
| Example 1 | | | |
| Comparative | 79.5 | 78.2 | 80.7 |
| Example 2 | | | |
| Comparative | 84.5 | 84.2 | 84.8 |
| Example 3 | | | |

TABLE 2

| Discharge | Central | Central | Peripheral |
|---|---|---|---|
| capacity | portion | portion | portion |
| (mAh/g) | A 150 | B 153 | A 155 |
| Example 1 | 350.2 | 348.1 | 349.3 |
| Example 2 | 339.7 | 341.3 | 341.8 |
| Comparative | 330.2 | 332.0 | 336.2 |
| Example 1 | | | |
| Comparative | 322.2 | 319.4 | 332.0 |
| Example 2 | | | |
| Comparative | 346.7 | 344.9 | 347.7 |
| Example 3 | | | |

Referring to Tables 1 and 2, the artificial graphite prepared in the box-type graphitization furnace according to the examples had a uniform degree of graphitization in the central and peripheral portions, and the lithium secondary batteries manufactured using the artificial graphite had a uniform discharge capacity. It can be seen that the box-type graphitization furnace according to the examples included a heating plate that was in contact with the bottom surface of the heating chamber and connected to the first power electrode and the second power electrode so as to extend across the interior of the heating chamber, thereby reducing the temperature gradient in the heating chamber.

In the case of Example 1, the variation in the degree of graphitization and discharge capacity depending on the location within the heating chamber was the smallest. Therefore, it can be seen that when the heating plate was connected to the central portion of the first power electrode and the central portion of the second power electrode, the heat generated by the heating plate was effectively transferred to the heating chamber.

Referring to Tables 1 and 2, the artificial graphite prepared in the box-type graphitization furnace according to Comparative Examples 1 and 2 had a degree of graphitization in the central portion that was at least about 1% and at most about 1.7% lower than that in the peripheral portion, and the lithium secondary batteries manufactured using the artificial graphite had a discharge capacity difference of about 10% or more. Therefore, it can be seen that the temperature gradient in the heating chamber was higher in the box-type graphitization furnace according to the comparative examples.

In Comparative Example 1, the absence of a heating plate prevented sufficient heat transfer to the central portion, resulting in uneven graphitization of the prepared artificial graphite and uneven capacity of the lithium secondary battery.

In Comparative Example 2, since the heating plate was not connected to the first power electrode and the second power electrode, it could not generate heat. Accordingly, the degree of graphitization of the prepared artificial graphite and the capacity of the lithium secondary battery were uneven.

In Comparative Example 3, the heat generated by the heater rods was transferred to the central portion, thereby reducing the variation in graphitization degree and discharge capacity depending on the location within the heating chamber. However, the variation was relatively greater than in the examples. When a plurality of heater rods not in contact with the bottom surface of the heating chamber were used, the heat transfer effect deteriorated and the temperature gradient in the heating chamber increased compared to the examples, resulting in a larger variation in the discharge capacity of the manufactured lithium secondary battery.

What is claimed is:

1. A box-type graphitization furnace comprising:
a heating chamber;
a first power electrode and a second power electrode disposed at opposite ends of the heating chamber, and
a heating plate that is in contact with a bottom surface of the heating chamber and connected to the first power electrode and the second power electrode so as to extend across the interior of the heating chamber.

2. The box-type graphitization furnace according to claim 1, wherein the heating plate is connected perpendicularly to the first power electrode and the second power electrode.

3. The box-type graphitization furnace according to claim 1, wherein the heating plate is connected to a central portion of the first power electrode and a central portion of the second power electrode.

4. The box-type graphitization furnace according to claim 1, wherein the heating plate is made of graphite.

5. The box-type graphitization furnace according to claim 1, wherein the heating plate is inserted into a groove formed in the bottom surface of the heating chamber.

6. The box-type graphitization furnace according to claim 1, wherein the heating plate is in contact with the first power electrode from a lower portion to an upper portion and with the second power electrode from the lower portion to the upper portion.

7. The box-type graphitization furnace according to claim 1, wherein a region inside the heating chamber is divided into two regions by the heating plate.

8. The box-type graphitization furnace according to claim 1, wherein the heating plate is in contact with a cover at the upper portion of the heating chamber.

9. A method for preparing artificial graphite, comprising:
charging the box-type graphitization furnace according to claim 1 with raw materials; and
heat-treating the raw materials to perform graphitization.

10. The method for preparing artificial graphite according to claim 9, wherein the heat treatment is performed by resistive heat generated by current.
